(19) United States
(12) Patent Application Publication
(10) Pub. No.: US 2023/0330777 A1
(43) Pub. Date: Oct. 19, 2023

(54) METHOD OF PROCESSING TWO-DIMENSIONAL SUBSTRATES

(71) Applicant: SCHOTT AG, Mainz (DE)

(72) Inventors: Volker Plapper, Alzey (DE); Michael Kluge, Offenbach am Main (DE); Kurt Nattermann, Ockenheim (DE)

(73) Assignee: SCHOTT AG, Mainz (DE)

(21) Appl. No.: 18/338,636

(22) Filed: Jun. 21, 2023

Related U.S. Application Data
(63) Continuation of application No. PCT/EP21/80593, filed on Apr. 11, 2021.

(30) Foreign Application Priority Data
Dec. 21, 2020 (DE) 10 2020 134 451.1

(51) Int. Cl. B23K 26/36

(52) U.S. Cl. CPC B23K 26/36; B23K 2103/54

(57) ABSTRACT

A method of processing two-dimensional substrates is provided. The method includes placing the substrate onto a substrate carrier and subjecting the substrate to a force acting towards the substrate carrier in an action zone of the substrate, but not in a compensation zone of the substrate. The substrate is predivided while being subjected to the force.

### CROSS REFERENCE TO RELATED APPLICATIONS

This application is a continuation of international application PCT/EP2021/080593 filed Apr. 11, 2021, which claims benefit under 35 USC § 119 of German Application 10 2020 134 451.1 filed Dec. 21, 2020, the entire contents of all of which are incorporated herein by reference.

### BACKGROUND

### 1. Field of the Invention

The invention relates to a method for processing, especially pre-separating, planar substrates, in particular glass substrates.

### 2. Description of Related Art

Various methods are known for separating glass substrates, for example so-called laser filamentation. In that method, in a first step, a defined material weakening is introduced into the material along a predetermined separation line by means of an ultrashort pulse laser (pre-processing or pre-separation). In a second step, the substrate is then separated along the preliminary damage which has been produced (separation process), wherein the separation of the material can be initiated, for example, by mechanically induced tensile stresses. Another method for separating glass substrates is scribe and break. In that method, in a first step, the material is scribed along a predetermined separation line by means of a scribing wheel, a diamond needle or a similar tool (pre-separation) and, in a second step, is separated along the separation line (separation process).

However, difficulties can occur especially when this method is used on thin glasses (e.g., <100 μm). These difficulties can be due to the fact that thin glasses having production-related borders especially are subject to intrinsic stresses following their hot forming process, such stresses being the consequence of the “freezing” of the state. The difference between the cooling rate in the thin substrate and in the thicker border region especially leads to the build up of stresses in the cooled state. These manifest themselves as metastable deformation of the glass substrate, so that, when lying on a flat processing table, it causes waves (“flatness”).

In order to achieve sufficient flatness for processing, for example by means of laser filamentation or scribing, the glass substrate can be tensioned and flattened on the supporting surface. However, this deformation results in additional stresses which, depending on the starting material, can be so great that the strengths of the processed separation lines are exceeded and they fracture uncontrollably. This can occur, for example, when the fixing is released, during which stresses in the material redistribute themselves and tensile stresses affect the processed separation line.

Uncontrolled fractures can in some cases even result in damage to the substrates to be produced. Such fractures can occur in an uncontrolled manner, for example, if the dominant stress (1st principal stress) exceeds the fracture strength but has a different geometric orientation to the preliminary damage which has been introduced. As a result, an uncontrolled fracture may also extend into the region of the final product.

The described difficulties become more critical especially as the size of the glass substrates increases, since the stresses that occur on flattening of the deformations from the hot forming process become greater.

### SUMMARY

Accordingly, the object underlying the invention is to provide a method for processing, especially pre-separating, a planar substrate which avoids the difficulties described above, especially makes it possible to pre-separate thin glass substrates, wherein the substrate holds together along pre-separated separation lines, especially does not fracture uncontrollably along such separation lines. Processing, especially pre-separation, is preferably to be possible even when internal tensile stresses prevail in the substrate and/or border regions are present and/or the substrate has a relatively large surface area. A further aspect of the object of the invention is to provide a device and optionally a suitable device for carrying out such a method.

In order to achieve this object, the invention discloses a method for processing, especially pre-separating, a planar substrate, especially a glass substrate, wherein the substrate is mounted on a substrate carrier, is subjected in the region of an action zone to a force acting in the direction of the substrate carrier, especially such that the substrate is brought closer to the substrate carrier in the region of the action zone, and is not subjected to the force acting in the direction of the substrate carrier in the region of an equalizing zone, especially such that the substrate is able to form temporary deformations in the region of the equalizing zone.

By tensioning the substrate especially in the region of action zone but not in the region of the equalizing zone, the flatness of the glass substrate can be increased locally, so that processing, for example by means of laser filamentation, scribing or other forms of processing, is made possible. At the same time, the stresses that occur in the substrate can be kept low, especially can be kept lower than in a substrate that is tensioned over its entire surface, that is to say flattened overall. This is because the energy required for the deformation is significantly less and thus the additional stresses occurring as a result of the deformation are also significantly lower.

In principle, the locally limited action zone can be provided at any desired location on the substrate, and the action zone can especially also be different from the location at which the substrate is processed and/or at which the locally increased flatness occurs.

Thus, for example, the material can be fixed only in small action zones which are remote, especially as remote as possible, from the zone to be processed. In the case of processing by means of a laser, but also generally, the flatness that is thereby achieved in the processing zone may, however, in some cases not yet be sufficient for processing the glass sheet by means of a laser at the focal position, for example.

Therefore, it may also be appropriate in the case of processing by means of a laser, but also generally, to tension the glass sheet in a sufficiently small region in or around the processing zone, such that it lies sufficiently flat on the substrate carrier in this zone.

The method for processing, especially pre-separating, a planar substrate preferably additionally comprises processing, especially pre-separating, the substrate, for example by means of laser filamentation, scribing or any type of pre-separation in general, while the substrate is being subjected in the region of the action zone to the force acting in the direction of the substrate carrier.

The method according to the invention is suitable in particular for thin substrates having a large surface area, wherein the substrate can have a usable area and a waste area (e.g., borders). The substrate preferably comprises brittle material, especially having intrinsic material stresses, for example glass, glass-like materials, ceramics or glass-ceramics, or consists of such a material.

Preferably, the substrate has in the region of a usable area a thickness which is less than 100 μm, preferably is less than 70 μm, particularly preferably is less than 50 μm, or is less than 40 μm.

Preferably, the substrate has a greater thickness in the region of a waste area, especially a thickness which is greater at least by a factor of 2, at least by a factor of 3 or at least by a factor of 5 than the thickness in the region of the usable area.

The waste area preferably comprises a peripheral region of the substrate extending along an edge of the substrate, particularly preferably two opposite peripheral regions of the substrate each extending along an edge of the substrate, between which the usable area is located, wherein the peripheral region or the two opposite peripheral regions of the substrate can be in the form of, for example, a border.

The waste area can further comprise one or two further peripheral regions of the substrate each extending along edges extending perpendicular thereto, for example such that, in the case of a four-sided substrate, a peripheral region that is to be removed is provided along each edge.

The substrate preferably has a length which is greater than 100 mm, preferably is greater than 300 mm, particularly preferably is greater than 500 mm, or is greater than 600 mm, or is greater than 700 mm. The length is to be understood as being especially the dimension that extends along the border.

The substrate preferably has a width which is greater than 100 mm, preferably is greater than 300 mm, particularly preferably is greater than 500 mm, or is greater than 600 mm, or is greater than 700 mm. The width is to be understood as being especially the dimension that extends perpendicular to the border.

Overall, the substrate can have a surface area which is greater than 0.01 m², is greater than 0.1 m² or also is greater than 0.25 m².

As already described, within the scope of the invention the substrate is subjected to a force not over its entire surface but only locally. The action zone within which the substrate is subjected to the force acting in the direction of the substrate carrier is especially smaller than 80% of the surface area of the substrate, preferably smaller than 60% of the surface area of the substrate, particularly preferably smaller than 40% of the surface area of the substrate.

The equalizing zone within which the substrate is not subjected to the force acting in the direction of the substrate carrier is especially larger than 20% of the surface area of the substrate, preferably larger than 40% of the surface area of the substrate, particularly preferably larger than 60% of the surface area of the substrate.

Especially in the case of processing by means of a laser, but also generally, it may be appropriate to subject the substrate to a force in the processing region, in the vicinity of the processing region or also around the processing region. In this case, but also generally, the lateral extent of the width around the zone to be processed can be determined or be able to be determined empirically from the material-specific stresses that are present. These can be very different depending on the hot forming process and the material.

It can be provided, for example, that the action zone in which the force acts comprises at least a portion of the waste area, especially of a peripheral region, especially of a border, and a portion of the usable area of the substrate.

Preferably, the action zone can be in the form of a strip which extends especially along the length of the substrate, especially extends along a border, wherein the strip has a width which is preferably less than 50% of the width of the substrate, particularly preferably is less than 40% of the width of the substrate, or is less than 30% of the width of the substrate.

In an exemplary embodiment of the invention, the action zone can, for example, also be located only on the inside or only on the outside, or a combination can also be provided in the case of different cuts (400).

The force acting according to the invention in the direction of the substrate carrier in the region of the action zone, which effects, for example, local fixing of the glass sheet, can be generated by different mechanisms, wherein there come into consideration, for example, vacuum, electrostatics or mechanics, but also other forms of force generation.

The force acting in the direction of the substrate carrier in the region of the action zone can be effected, for example, by application of a low pressure at the surface of the substrate facing the substrate carrier, especially by means of openings in the substrate carrier or an open porosity of the substrate carrier. The force can, for example, also be exerted on the substrate from above by means of a holding-down device. Furthermore, the force can also be effected by an electric voltage source (e.g., charging system, ionization system).

The force acting in the direction of the substrate carrier in the region of the action zone can also be effected by electrostatic charging of the substrate and/or of the substrate carrier.

The force acting in the direction of the substrate carrier in the region of the action zone can further be effected by mechanical pressing or pulling of the substrate onto the substrate carrier.

Accordingly, the force acting in the direction of the substrate carrier, to which the substrate is subjected in the region of the action zone, is generally, in the physical sense, especially an area-based force (“pressure” or “surface force”).

Regardless of how the force is effected in the region of the action zone, the flatness of the substrate, especially in the region of the action zone, can, however, in principle also be increased outside the action zone. At the same time, because the action zone is locally limited, the stresses that occur in the substrate can be kept low, especially can be kept lower than in the case of a substrate that is tensioned overall.

While the substrate is being subjected in the region of the action zone to the force acting in the direction of the substrate carrier, the maximum distance between the substrate carrier and the substrate in the region of the action zone can be less than 5 mm, preferably less than 3 mm, particularly preferably less than 1 mm.

The states so generated can be described as bistable. The numerical values mentioned by way of example can be present only locally. In addition, the distance can in some cases be dependent on the material thickness and/or the initial material stresses. In one example, the mentioned numerical values can be given, for example, in the case of a substrate having a thickness of less than 100 μm, especially of less than 70 μm or even of less than 50 μm. In one example, the numerical values can be obtained in the case of a substrate which, without further action from outside, has an elevation above the contact plane of more than 4 mm in some regions.

Furthermore, while the substrate is being subjected in the region of the action zone to the force acting in the direction of the substrate carrier, the maximum tensile stress in the substrate, especially comprising the action zone and the equalizing zone, can be less than 50 MPa, preferably less than 30 MPa, particularly preferably less than 20 MPa.

Furthermore, while the substrate is being subjected to the force in the region of the action zone, the maximum tensile stress in the substrate in the region of the action zone can be less than 33 MPa, preferably less than 20 MPa, particularly preferably less than 15 MPa.

Compared to the tensile stresses mentioned above, tensile stresses of up to or in the region of 100 MPa can form in one example in the peripheral region in the case of a substrate pulled flat over its entire surface.

The above-indicated values in MPa can be able to be determined, for example, by means of simulation. As a result of zonal tensioning, the stress can migrate more greatly to the edge.

As already described, the method according to the invention for processing, especially pre-separating, a planar substrate preferably also comprises processing, especially pre-separating, the substrate while the substrate is being subjected to the force in the region of the action zone.

The processing, especially the pre-separation, of the substrate preferably takes place along a predetermined separation line which can extend at least in part, or also predominantly, within the action zone.

The predetermined separation line preferably extends along the length of the substrate, especially along a border, wherein the separation line especially separates the waste area from the usable area, so that the waste area can be removed and a glass substrate in the form of an end product can be produced from the usable area.

In principle, separation lines can extend linearly, can extend in a curved manner, and/or a plurality of separation lines which intersect can also be provided. Especially in the case of intersecting separation lines, sequential processing can be provided.

The processing, especially the pre-separation, of the substrate preferably comprises introducing laser radiation into the substrate, especially in the region of the action zone. Areas of damage which especially are next to one another and spaced apart from one another along the predetermined separation line can here be introduced into the substrate, wherein the areas of damage are preferably in the form of areas of filamentary damage and particularly preferably are produced by means of pulsed laser radiation of an ultrashort pulse laser.

The processing, especially the pre-separation, of the substrate can generally comprise introducing preliminary damage of any kind into the substrate, especially in the region of the action zone. Damage can be introduced into the substrate especially along the predetermined separation line, wherein the damage can be effected, for example, by means of a laser, by means of a scribing wheel, by means of a needle (e.g., diamond needle) or other tools for processing the substrate.

The action zone within which the substrate is subjected to a force acting in the direction of the substrate carrier can especially be in the form of a strip along a first border, and the predetermined separation line along which the pre-separation of the substrate takes place can extend next to the border, especially can extend along the entire length of the substrate, such that the border can be removed along the separation line.

An advantage of the method according to the invention is that the overall stresses remain low, so that the preliminary damage of the substrate can also take place beyond the glass edge. By contrast, tests have shown that, in the case of fixing over the entire surface, it is frequently not possible to introduce preliminary damage beyond the glass edge, but rather a sufficient distance is necessary in order that uncontrolled separation does not occur. The reason for this is that the tensile stresses at the substrate edge that occur as a result of the flattening of the dominant deformation of large local wavelength (dome, dish, arch) are so high that they frequently exceed the fracture strength of a preliminary damage.

In a development, different combinable action zones can be provided, which, depending on the process, can locally tension and/or fix flat the specific regions.

There can preferably be provided, for example, a second action zone in the form of a strip along a second border located opposite the first border, and there can be provided a second predetermined separation line which extends next to the second border, especially extends along the entire length of the substrate, such that the second border can be removed along the separation line.

Furthermore, there can also be provided a third and optionally fourth action zone which are each in the form of, for example, a strip along a peripheral region extending perpendicular to a border, and there can be provided a third and optionally fourth predetermined separation line which each extend next to the edge of the substrate, such that the respective peripheral region can be removed along the separation line.

In the case of a plurality of action zones, the application of force within the plurality of action zones can take place in succession in time. While the force is being applied within a specific action zone, the pre-separation along the associated separation line, that is to say especially the separation line extending through that action zone, is carried out. It can further be provided that the application of force takes place simultaneously within a plurality of groups of action zones of the plurality of action zones and takes place in succession in time between the groups of action zones. For example, it can be provided that the zones “overlap”, that is to say can be activated in temporal sequence such that, for example, a plurality of zones are active at the same time (e.g., the first zone and the second zone and then the third zone and the fourth zone).

The method for processing, especially pre-separating, a planar substrate can additionally also comprise a separation step following the pre-separation. The method can, for example, be carried out in a processing system having a plurality of processing stations, wherein one processing station is adapted for the pre-separation and a further processing station is adapted for the separation.

Especially, after the pre-separation of the substrate along the designated separation line or separation lines has taken place (e.g., has taken place in a processing station adapted for the pre-separation), separation of the substrate along the designated separation line or separation lines can take place (e.g., can take place in a processing station adapted for the separation).

During the separation, the substrate can again preferably be subjected to a force acting in the direction of the substrate carrier, wherein this force can act especially in the region of the usable area.

Before the pre-separation of the substrate along the designated separation line or separation lines takes place (e.g., takes place in a processing station adapted for the pre-separation), application of the substrate to the substrate carrier can further take place (especially can take place in a processing station adapted for the application).

The substrate can also be subjected during the application to a force acting in the direction of the substrate carrier, which force can act, for example, in the region of the usable area and also in the region of the waste area, wherein the force especially first acts in the region of the usable area and then acts in the region of the waste area in order to apply the substrate to the substrate carrier from the inside to the outside.

The various processing stations can be configured to be spatially separate from one another, for example can be arranged spatially next to one another in a processing system.

The substrate carrier can especially be configured to be movable and during the method, for example, can be moved from one processing station to the next processing station. The substrate carrier can, for example, be movable within a system. The substrate carrier can also be configured to be transportable, for example such that it can be transported between stations or systems (e.g., by a roller conveyor, a robot and/or a driverless transport system).

The invention relates further to a substrate carrier for the mounting of a planar substrate for processing of the substrate, especially by a method as described above.

The substrate carrier has means for subjecting a mounted substrate within an action zone to a force acting in the direction of the substrate carrier. The means are in the form of, for example, openings in the substrate carrier or in the form of an open porosity of the substrate carrier, in order to exert a low pressure on a substrate mounted on the substrate carrier.

In the case of openings in the substrate carrier, the openings can have, for example, a diameter of between 0.5 mm and 12 mm, preferably between 1 mm and 6 mm. The openings can be in the form of, for example, cylindrical or quasi-cylindrical channels. In the case of an open porosity, this can be the result of powder metallurgy processes.

In general, the means for exerting the force can preferably be configured to ensure a local exertion of force. For example, it can be provided that the structure of the tensioning system (e.g., of the vacuum or of the vacuum system) can form sufficiently well locally. Preferably, crosstalk to other zones is here excluded or largely avoided. In the case of a vacuum, this can in some cases be facilitated by small diameters of the openings.

The substrate carrier can in principle comprise or consist of different materials, for example can comprise or consist of plastics material or ceramics.

The substrate carrier is preferably configured to be movable and/or transportable, so that it can be moved, together with a mounted substrate, especially from one processing station to the next processing station and/or between systems.

In one exemplary embodiment, the substrate carrier comprises an action region within which the means for exerting force are arranged, wherein the action region is smaller than 80% of the surface area of the substrate carrier, preferably is smaller than 60% of the surface area of the substrate carrier, particularly preferably is smaller than 40% of the surface area of the substrate carrier, and/or an equalization region within which no means for exerting force are arranged, wherein the equalization region is larger than 20% of the surface area of the substrate carrier, preferably is larger than 40% of the surface area of the substrate carrier, particularly preferably is larger than 60% of the surface area of the substrate carrier.

The action region can also be smaller than 70% of the surface area of the substrate carrier or smaller than 30% of the surface area of the substrate carrier.

The action region can be, for example, in the form of a strip which especially has a width which is less than 50% of the width of the substrate carrier, particularly preferably is less than 40% of the width of the substrate carrier, or is less than 30% of the width of the substrate carrier. The substrate carrier can further preferably comprise a second action region, which particularly preferably extends parallel to the first action region, and can further preferably comprise a third and optionally a fourth action region, which particularly preferably extend perpendicular to the first or second action region.

An action region in the form of a strip can also have a width which is less than 70% of the width of the substrate carrier.

The invention relates further to a processing system for processing, especially for pre-separating and/or separating, a planar substrate, especially a glass substrate, mounted on a substrate carrier.

The processing system comprises a processing station adapted for the pre-separation, for pre-separating the planar substrate mounted on the substrate carrier along a predetermined separation line, for example comprising an ultrashort pulse laser, for introducing areas of damage into the substrate next to one another and spaced apart from one another along the predetermined separation line, or, for example, a scribing wheel or, for example, a needle for scribing an area of damage into the substrate along the separation line.

The processing station adapted for the pre-separation preferably comprises means for effecting a force in order to subject the substrate mounted on the substrate carrier within an action zone to a force acting in the direction of the substrate carrier, wherein the means are in the form of, for example, a low pressure source for applying a low pressure at openings in the substrate carrier or at an open porosity of the substrate carrier, or, for example, in the form of a holding-down device or, for example, in the form of an electric voltage source.

The processing system preferably further comprises a processing station adapted for the separation, for separating the planar substrate mounted on the substrate carrier along the designated separation line after the pre-separation.

The processing station adapted for the separation again preferably comprises means for effecting a force in order to subject the substrate mounted on the substrate carrier to a force acting in the direction of the substrate carrier, wherein the force acts especially in the region of the usable area of the substrate, wherein the means are especially in the form of a low pressure source for applying a low pressure at openings in the substrate carrier or at an open porosity of the substrate carrier, or, for example, in the form of a holding-down device or, for example, in the form of an electric voltage source.

The processing system preferably further comprises a processing station adapted for the application, for applying the planar substrate mounted on the substrate carrier to the substrate carrier before the pre-separation.

The processing station adapted for the application again preferably comprises means for effecting a force in order to subject the substrate mounted on the substrate carrier to a force acting in the direction of the substrate carrier, wherein the force acts especially in the region of the usable area and in the region of the waste area of the substrate in order to apply the substrate to the substrate carrier from the inside to the outside, wherein the means are especially in the form of a low pressure source for applying a low pressure at openings in the substrate carrier or at an open porosity of the substrate carrier, or, for example, in the form of a holding-down device or, for example, in the form of an electric voltage source.

The substrate carrier can be passed from processing station to processing station in the system. The processing system accordingly preferably comprises a substrate carrier conveyor for moving a substrate carrier, together with a substrate mounted thereon, from one processing station to the next processing station.

In principle, each of the processing stations can have a low pressure source, a holding-down device and/or a voltage source for effecting a force within corresponding action zones. It can be provided that no force is exerted while the substrate carrier is being transported.

On the other hand, it can also be provided that the force is maintained while the substrate carrier is being moved or transported. For example, that the substrate carrier comprises a low pressure source, such that there is a low pressure, for example, also while the substrate carrier is being passed along. In this case, the substrate can, for example, remain fixed over a plurality of working stations. The tensioning technique can accordingly in principle be maintained also during transport, that is to say, for example, during transfer between two processing stations.

Finally, the invention relates also to a substrate, especially which is able to be produced or has been produced by a method as described above. The substrate preferably comprises brittle material, especially having intrinsic material stresses, for example glass, glass-like materials, ceramics or glass-ceramics, or consists of such a material.

The substrate has a thickness which is less than 100 μm, preferably is less than 70 μm, particularly preferably is less than 50 μm, or is less than 40 μm, and a surface area which is greater than 0.01 m², preferably is greater than 0.1 m², particularly preferably is greater than 0.25 m².

The substrate further has at least one substrate edge which is produced by separation of a designated separation line produced by pre-separation, especially a designated separation line produced by means of a laser, a scribing wheel or a needle. In the case of a separation line produced by means of a laser, the substrate can have areas of filamentary damage which are spaced apart from one another and which are arranged next to one another along at least one edge of the substrate.

### BRIEF DESCRIPTION OF THE DRAWINGS

The invention will be explained in greater detail below with reference to some figures, in which:

FIG. 1 shows a top view of a glass substrate,

FIG. 2 shows a sectional side view of a glass substrate on a substrate carrier, and

FIG. 3 shows a top view of a glass substrate having action regions and designated separation lines.

### DETAILED DESCRIPTION

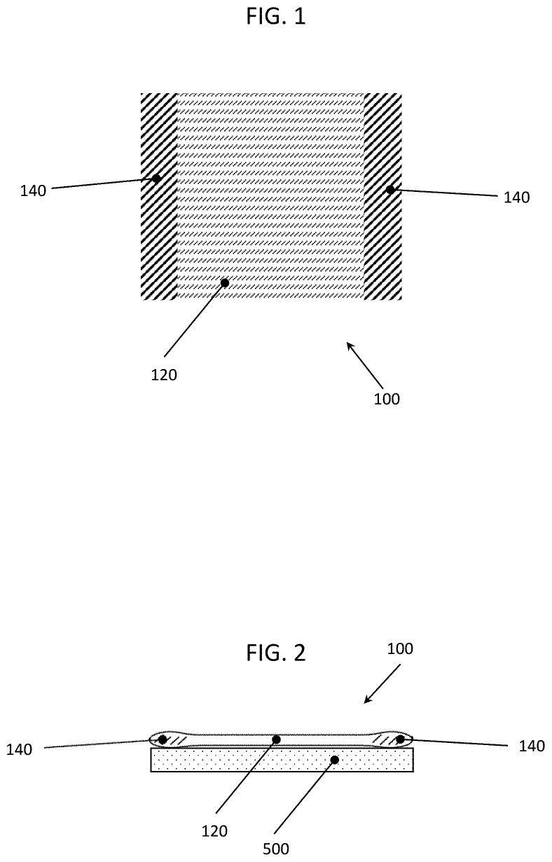

FIG. 1 shows a top view of a substrate 100 having a usable area 120 and a waste area 140. The waste area 140 comprises two opposite peripheral regions of the substrate each extending along an edge of the substrate 100 and between which the usable area 120 is located. The two opposite peripheral regions of the substrate are in this case in the form of opposite borders of the substrate 100.

FIG. 2 shows a sectional side view of the substrate 100, which in this example is in the form of thin glass. In the region of the usable area 120, the substrate 100 has a thickness which is, for example, less than 100 μm. However, the substrate has a greater thickness in the region of the waste area 140, which in this example comprises the two opposite borders.

For processing the substrate 100, especially for pre-separating it, the substrate is mounted on a substrate carrier 500. It is frequently desirable to singulate the thin flat glass substrate in a defined manner, that is to say, for example, to remove the two opposite borders. Owing to intrinsic internal stresses in the substrate 100, which can result, for example, during production from the different cooling rate of the substrate 100 in the region of the usable area 120 and in the region of the thicker waste area 140, the substrate 100 does not lie flat on the substrate carrier 500 but rather is at locally different distances from the substrate carrier.

In order to counteract this, it is possible in principle to effect on the substrate 100 a force acting over the whole surface in the direction of the substrate carrier 500, for example by means of a planar vacuum system, in order to achieve sufficient flatness for processing. However, this has the disadvantage that additional stresses occur in the substrate 100, and these additional stresses hinder or impede reliable processing, especially controlled pre-separation of the substrate 100.

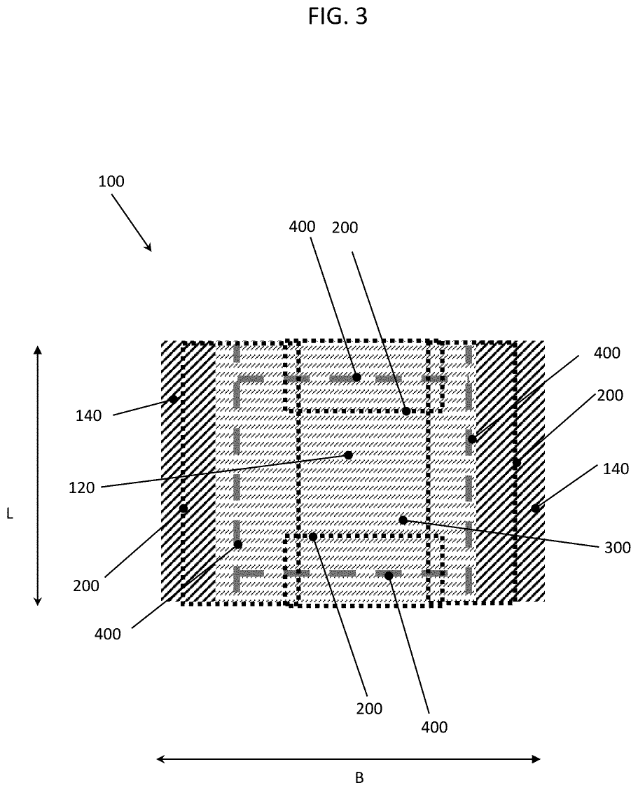

FIG. 3 shows a top view of a substrate 100, wherein the substrate 100 is subjected in the region of locally limited action zones 200 (regions delimited by dotted lines) to a force which acts in the direction of the underlying substrate carrier 500. In the region of an equalizing zone 300, which especially comprises the middle of the substrate, the substrate 100 is not subjected to the force acting in the direction of the substrate carrier 500.

The processing, especially the pre-separation, of the substrate 100 takes place along predetermined separation lines 400, which in the example shown each extend through one of the action zones 200 or are even located predominantly or wholly in the action zones 200. In the example shown, there are provided on the one hand two opposite action zones 200, which extend in the form of strips along the length L and which comprise in part a region of the usable area 120 and in part a region of the waste area 140. On the other hand, there are also provided two action zones 200 running perpendicular thereto.

While the force is being applied within an action zone 200, pre-separation can take place along a respective separation line 400. The processing of the different zones can take place simultaneously or in succession.

Surprisingly, it has been found that sufficient flatness of the substrate along a separation line 400 can easily be achieved by bringing the substrate 100 closer to the substrate carrier 500 in a sufficiently small action zone 200 in or around the separation line 400, such that the substrate lies sufficiently flat on the substrate carrier 500 in the action zone 200.

In principle, however, depending on the boundary conditions, it is also possible to provide action zones 200 which are located at a location other than an associated separation line 400. For example, it is also conceivable to fix the substrate only in small zones, as far away as possible from the zone to be processed. However, depending on the intrinsic internal stresses and properties of the substrate, this can have the result that sufficient flatness for processing is no longer achieved in the zone to be processed, for example for processing a glass sheet by means of a laser at the focal position. In such a case, a separation line 400 in the vicinity of or within the action zone 200 would accordingly be advantageous.

An exemplary embodiment of the substrate 100 relates to ultra-thin glass having a thickness of less than 100 μm, especially less than 70 μm, for example 40 μm or less than 40 μm. The action zone 200 can, for example, have a width of at least 10 mm, preferably at least 20 mm, for example 30 mm (+−15 mm) or more than 30 mm around the separation line (processing zone). The separation line 400 can extend, for example, at a distance of 50 mm from the glass edge (border) and can be formed, for example, by a USP laser by means of perforation. The invention advantageously allows substrates to be tensioned, processed and relaxed again without the preliminary damage fracturing uncontrollably, even if the separation line 400 reaches as far as the glass edge. In comparative examples, with identical settings and with tensioning over the entire surface (i.e., when the substrate is fixed flat over its entire surface), all the substrates are uncontrollably fractured on relaxation. The invention is suitable for a large number of substrates, for example for brittle materials, especially those having intrinsic material stresses, such as, for example, glass substrates or glass-like substrates, for example technical and optical glasses or also ceramics or glass-ceramics.

What is claimed is:

1. A method for processing a two-dimensional substrate, comprising:
mounting the substrate on a substrate carrier, the substrate having an action zone, an equalization zone, a usable area, and a waste area;
subjecting the action zone to a force acting in a direction towards the substrate carrier such that the substrate is brought closer to the substrate carrier in the region of the action zone without subjecting the equalization zone to the force to form a temporary deformation in the substrate in a region of the equalizing zone; and
performing a pre-separation process on the substrate while subjecting the action zone to the force.

2. The method of claim 1, wherein the usable area has a thickness less than 100 μm and the waste area has a thickness that is greater at least by a factor of 2 than the thickness of the usable area.

3. The method of claim 1, wherein the waste area comprises a peripheral region of the substrate extending along an edge of the substrate.

4. The method of claim 1, wherein the substrate has a length greater than 100 mm and a width greater than 100 mm.

5. The method of claim 1, wherein the substrate has a surface area greater than 0.01 m².

6. The method of claim 1, wherein the substrate has a feature selected from a group consisting of: the action zone being smaller than 80% of a surface area of the substrate, the action zone being smaller than 60% of a surface area of the substrate, the action zone being smaller than 40% of a surface area of the substrate, the equalizing zone being larger than 20% of a surface area of the substrate, the equalizing zone being larger than 40% of a surface area of the substrate, the equalizing zone being larger than 60% of a surface area of the substrate, the action zone comprising at least a portion of the waste area and a portion of the usable area, the action zone comprising a strip that extends along a length of the substrate, and the action zone comprising a strip that extends along a border of the substrate.

7. The method of claim 1, wherein the step of subjecting the action zone to the force comprises a step selected from a group consisting of: applying a pressure at a surface of the substrate facing the substrate carrier through the substrate carrier, electrostatic charging of the substrate and/or of the substrate carrier, mechanically pressing or pulling the substrate onto the substrate carrier, and any combinations thereof.

8. The method of claim 1, further comprising a step selected from a group consisting of: maintaining a maximum distance between the substrate carrier and the substrate in the action zone of less than 5 mm during the step of subjecting the action zone to the force, maintaining a maximum distance between the substrate carrier and the substrate in the action zone of less than 3 mm during the step of subjecting the action zone to the force, maintaining a maximum distance between the substrate carrier and the substrate in the action zone of less than 1 mm during the step of subjecting the action zone to the force, maintaining a maximum tensile stress in the substrate of less than 50 MPa during the step of subjecting the action zone to the force, maintaining a maximum tensile stress in the substrate of less than 30 MPa during the step of subjecting the action zone to the force, maintaining a maximum tensile stress in the substrate of less than 20 MPa during the step of subjecting the action zone to the force, maintaining a maximum tensile stress in the action zone of less than 33 MPa during the step of subjecting the action zone to the force, maintaining a maximum tensile stress in the action zone of less than 20 MPa during the step of subjecting the action zone to the force, maintaining a maximum tensile stress in the action zone of less than 15 MPa during the step of subjecting the action zone to the force, and any combinations thereof.

9. The method of claim 1, wherein the step of performing the pre-separation process comprises forming areas of damage in the substrate next to one another and spaced apart from one another along a separation line.

10. The method of claim 9, wherein the separation line extends at least in part within the action zone.

11. The method of claim 10, wherein the separation line separates the waste area from the usable area.

12. The method of claim 9, wherein the step of forming areas of damage comprises introducing laser radiation into the substrate in the action zone to form areas of damage in the substrate next to one another and spaced apart from one another along a separation line.

13. The method of claim 9, wherein the step of forming areas of damage comprises using pulsed laser radiation of an ultrashort pulse laser to form of areas of filamentary damage in the substrate along a separation line.

14. The method of claim 9, wherein the step of forming areas of damage comprises using a scribing wheel or a needle to introduce damage into the action zone along a separation line.

15. The method of claim 1, wherein the separation line extends next to an edge of the substrate such that a peripheral region of the substrate can be removed along the separation line.

16. The method of claim 1, wherein the step of subjecting the action zone to the force comprises subjecting a plurality of action zones to the force at separate times or simultaneously.

17. The method of claim 9, further comprising separating the substrate along the separation line.

18. The method of claim 17, wherein the step of separating the substrate comprises applying a separation force in the usable area in the direction towards the substrate carrier.

19. A substrate carrier for mounting of a planar substrate during processing, comprising:
a substrate supporting surface configured to support the planar substrate; and
openings and/or open porosity in the substrate carrier configured to exert a low pressure on the planar substrate through the substrate supporting surface when the planar substrate is supported by the substrate supporting surface.

20. A processing system for a planar substrate, comprising:
a substrate carrier having a substrate supporting surface and openings and/or open porosity in the substrate carrier, the substrate supporting surface being configured to support the planar substrate;
a force application system configured to exert a low pressure through the openings and/or open porosity on the planar substrate towards the substrate supporting surface when the planar substrate is supported by the substrate supporting surface so as to form a temporary deformation in the substrate; and
a processing station configured to form areas of damage in an action zone of the planar substrate next to one another and spaced apart from one another along a separation line while the force application system exerts the low pressure on the planar substrate.
